(19) United States
(12) Patent Application Publication
(10) Pub. No.: US 2006/0077968 A1
(43) Pub. Date: Apr. 13, 2006

(54) In-home Voice-Over-Internet-Protocol telephony distribution

(75) Inventors: George N. Pitsoulakis, Orland Park, IL (US); Christopher F. Simanonis, Winfield, IL (US); Mark S. Ziermann, Bolingbrook, IL (US); Mark Joseph Beegle, Shorewood, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Westell Technologies, Inc., Aurora, IL (US)

(21) Appl. No.: 11/241,465

(22) Filed: Sep. 30, 2005

Related U.S. Application Data
(60) Provisional application No. 60/614,933, filed on Sep. 30, 2004.

(51) Int. Cl. H04L 12/66

(52) U.S. Cl. 370/352

(57) ABSTRACT

Several examples for in-home Voice-Over-Internet Protocol (VOIP) telephony distribution are described. In one example, an analog telephone adapter may be modified to provide wireless capabilities. In another example, an isolation device or circuit may be added to a Network Interface Device or a Central Office. In yet another example, a second pair of wires may be used to provide VOIP service. As a result of implementing any one of these examples, a user may place a VOIP call throughout the user's home without being tethered to a fixed location.

### RELATED APPLICATIONS

The present patent application claims priority under 35 U.S.C. § 119(e) to U.S. Provisional Patent Application Ser. No. 60/614,933, which was filed Sep. 30, 2004. The full disclosure of U.S. Provisional Patent Application Ser. No. 60/614,933 is incorporated herein by reference.

### FIELD

The present invention relates generally to Voice-Over-Internet-Protocol (VOIP) telephony, and more particularly, relates to in-home VOIP telephony distribution solutions.

### BACKGROUND

VOIP telephony is a low-cost alternative to the traditional telephone system, which is sometimes referred to as the Plain Old Telephone System (POTS). VOIP telephony allows callers to make toll-free long distance voice and fax calls over existing Internet Protocol (IP) networks, instead of using the Public Switched Telephone Network (PSTN). Any IP network, including the Internet, private Intranets, Integrated Services Digital Networks (ISDN), Digital Subscriber Lines (DSL), Cable (e.g., using Data Over Cable Service Interface Specifications (DOCSIS)) frame relays, wireless networks, and satellite networks, can route calls using VOIP technology.

Typically, a user of VOIP service is equipped with a device called an Analog Telephone Adapter (ATA). The ATA interfaces a standard analog telephone (sometimes referred to as a POTS telephone) to an IP-based interface, usually using an Ethernet connection to a broadband router or integrated into the broadband router. In addition to performing voice conversion from the analog to the digital domains, the ATA communicates with a VOIP soft-switch located somewhere on the Internet. The VOIP soft-switch, also referred to as a Media Gateway Controller (MGC), provides call control and routing functions. The ATA's access to the Internet is usually provided via a broadband device, typically, a DSL modem or a cable modem. Alternatively, the modem and the ATA functions can be combined into a single integrated access device (IAD).

Unlike conventional telephone service, where the user is free to make a call from practically anywhere in the home, a user of a typical in-home VOIP implementation is effectively tethered to the ATA or the IAD. This causes the user to place VOIP calls from a fixed location in the home. This may be inconvenient for users who need or would like to move around the home when connected to a VOIP call.

It would be beneficial if the user could make a VOIP call in his home with the same degree of freedom the user has with conventional telephone service.

### SUMMARY

Examples of in-home VOIP distribution are described. In a first example, an in-home Voice-Over-Internet Protocol (VOIP) distribution system includes a cordless analog telephone adapter extension connected to a wired communications device and a wireless integrated access device connected to a data network. The wireless integrated access device communicates wirelessly with the cordless analog telephone adapter extension.

The wired communications device may be a landline telephone, a cordless telephone, a facsimile machine, or a text telephone device. The wireless integrated access device may include a modem and a wireless analog telephone adapter. The wireless analog telephone adapter is an analog telephone adapter that is modified by adding wireless access to an analog voice interface of the analog telephone adapter.

The data network may be the Internet, an Intranet, an Integrated Service Digital Network (ISDN), a Digital Subscriber Line (DSL), cable (e.g., using Data Over Cable Service Interface Specifications (DOCSIS)), a frame relay, an Ethernet, a wireless Local Area Network (LAN), a wireless Wide Area Network(WAN), or a satellite network. The wireless integrated access device communicates wirelessly with the cordless analog telephone adapter extension via a wireless link that is based on Digital Enhanced Cordless Telephone (DECT), Wideband Digital Enhanced Cordless Telephone (WDECT), proprietary cordless telephones 900 MHz/2.4 GHz/5.8 GHz, Bluetooth, Ultra Wide Band (UWB), or Wireless Fidelity (Wi-Fi) standards.

A method of providing in-home Voice-Over-Internet Protocol (VOIP) distribution is also described. The method includes connecting a wired communications device to a cordless analog telephone adapter extension and connecting a wireless integrated access device to a digital network. The wireless integrated access device is operable to communicate wirelessly to the cordless analog telephone adapter extension.

In another example, a VOIP distribution system includes a wired communications device connected to in-home wiring, an integrated access device connected to the in-home wiring, and an isolator controlled by the integrated access device. The operational status of the isolator determines whether the wired communications device provides VOIP service.

The isolator is either located in a network interface device or in a Central Office. The integrated access device controls the operational status of the isolator with at least one tone and DC signaling.

In another example, an in-home VOIP distribution system includes an adapter for switching between a first pair of wires and a second pair of wires, and an integrated access device connected to the first pair of wires and the second pair of wires. When the adapter connects a telephone to the first pair of wires, the telephone receives Plain Old Telephone Service (POTS). When the telephone adapter connects the telephone to the second pair of wires, the telephone receives VOIP service.

The adapter includes a relay for switching between the first pair of wires and the second pair of wires. A Digital Subscriber Line (DSL) interface in the integrated access device is connected to the first pair of wires. Analog Telephone Adapter/Foreign Exchange Station (ATA/FXS) circuitry in the integrated access device is connected to the second pair of wires.

As a result of implementing any one of these examples, a user may place a VOIP call throughout the user's home, similar to making a conventional telephone call using a cordless telephone. These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a block diagram of a distribution system, according to a first example;

FIG. 2 is a block diagram of a wireless analog telephone adapter for use in the distribution system depicted in FIG. 1, according to an example;

FIG. 3 is a block diagram of a cordless analog telephone adapter extension for use in the distribution system depicted in FIG. 1, according to an example;

FIG. 4 is a block diagram of a cordless telephone extension for use in the distribution system depicted in FIG. 1, according to an example;

FIG. 5 is a block diagram of distribution system, according to another example;

FIG. 6 is a block diagram of a network interface device isolator for use in the distribution system depicted in FIG. 5, according to an example;

FIG. 7 is a schematic of a detector circuit for use in the network interface device isolator depicted in FIG. 6, according to an example;

FIG. 8 is a block diagram of distribution system, according to another example;

FIG. 9 is a schematic of an isolator for use in a Central Office depicted in FIG. 8, according to an example; and

FIG. 10 is a block diagram of distribution system, according to another example.

### DETAILED DESCRIPTION

Several examples for in-home VOIP telephony distribution are described herein. As a result of implementing any one of these examples, a user may place a VOIP call throughout the user's home, providing a level of freedom previously only experienced with conventional telephone systems. While several examples are described, it is understood that additional methods and systems may be implemented without departing from the scope of the invention.

Adding Wireless Capability to a Analog Telephone Adapter

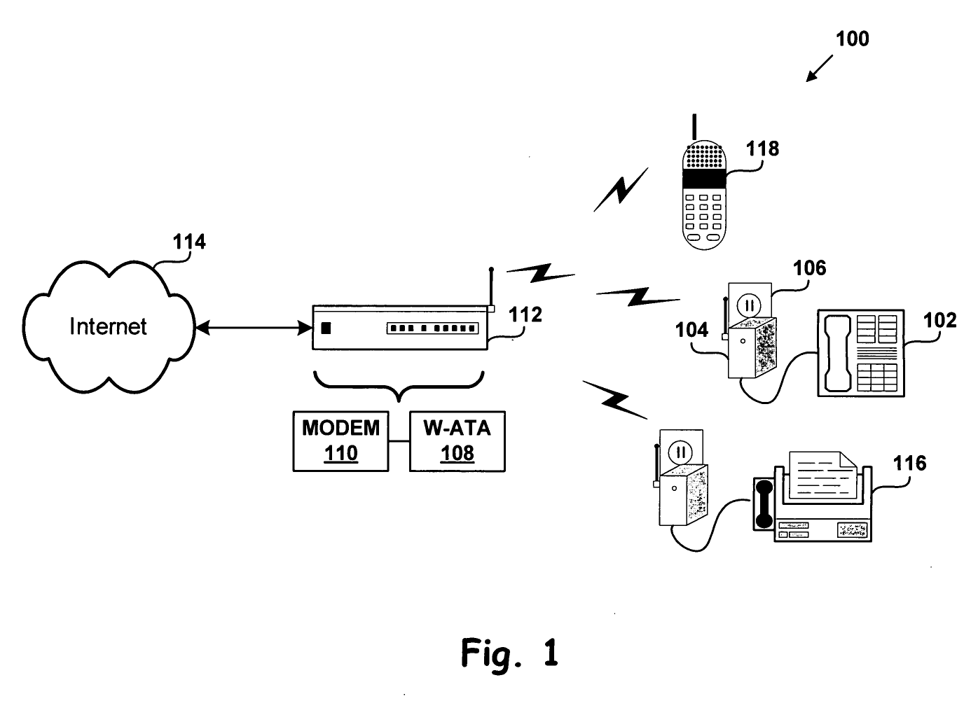

A user can place VOIP calls with the same degree of freedom the user has with conventional telephone service by adding wireless access to an analog telephone adapter (ATA). More specifically, the ATA's analog voice interface is modified to add wireless access. As a result, wireless connection to the ATA is provided by cordless analog telephone adapter extensions (C-ATAX's) and/or wireless handsets. This solution is described in more detail with respect to FIGS. 1-4.

FIG. 1 is a block diagram of a distribution system 100. The distribution system 100 includes a broadband network 114, which is depicted in FIG. 1 as the Internet. However, the broadband network 114 can be any type of data network, such as an Intranet, ISDN, DSL, cable, frame relay, Ethernet, wireless, or satellite network.

The broadband network 114 is connected to a modem 110. The modem 110 is a device that is well known device for modulating outgoing digital signals from a computer or other digital device to analog signals for a conventional twisted pair telephone line, and demodulating an incoming analog signal and converting the signal to a digital signal for the digital device. The modem 110 can be any conventional modem, such as a DSL modem or a cable modem, or any device developed in the future used for modulating and demodulating signals.

The modem 110 is connected to a wireless analog telephone adapter (W-ATA) 108. The W-ATA 108 is a modified ATA. The ATA is a conventional device known in the art for connecting a telephone to a computer or network so that the user can make calls over the Internet. The W-ATA 108 has been modified by adding wireless access to the ATA's analog voice interface. As depicted in FIG. 1, the modem 110 and the W-ATA 108 may be combined to form a single wireless IAD (W-IAD) 112. While the W-IAD 112 is used in the following description, it is understood that the functions of the W-IAD 112 may be split between the W-ATA 108 and the modem 110.

The W-IAD 112 can communicate wirelessly with a wireless handset 118. For example, the wireless handset 118 may be a cordless telephone extension. Additionally, the W-IAD 112 can communicate wirelessly via a Cordless Analog Telephone Adapter Extension (C-ATAX) 104 with any wired device. For example, the wireless IAD 112 can communicate with a standard POTS telephone 102 via the C-ATAX 104. The POTS telephone 102 may be a landline or cordless telephone. Additionally, the W-IAD 112 can communicate with a facsimile machine 116, a text telephone (TTY) device, or any other wired communication device.

The C-ATAX 104 acts as an extension to the W-ATA 108. The C-ATAX 104 allows the POTS telephone 102 and/or the fax 116 to communicate wirelessly to the W-ATA 108. While FIG. 1 depicts the C-ATAX 104 inserted into an AC power outlet 106, the C-ATAX 104 can be AC or DC powered. By plugging the POTS telephone 102 into the C-ATAX 104, the user is free to make VOIP calls from anywhere in the user's home.

The W-IAD 112 may communicate with each C-ATAX 104 and wireless handset 118 in a plurality of different ways. Each C-ATAX 104 and wireless handset 118 may be provisioned to ring as one line. Alternatively, each C-ATAX 104 and wireless handset 118 may be mapped to a specific telephone number and ring pattern generated by the W-IAD 112. In this example, each C-ATAX 104 and wireless handset 118 is programmed with a different telephone number and rings when an incoming call is made to that particular telephone number. Thus, the W-IAD 112 may be scaled to support N telephone calls, where N or a subset of N calls can be made simultaneously. In either case, the C-ATAX 104 and wireless handset 118 may be extended to support more extensions than the W-IAD 112 can support simultaneous calls on. The C-ATAX 104 and wireless handset 118 are capable of alerting a user that there is an incoming call for another number by playing distinctive ring tones or music tied to each extension.

This example allows for other value-added feature enhancements, such as distinct or selective ringing. For example, using caller identification information, the C-ATAX 104 and wireless handset 118 may provide distinctive ring tones to identify certain callers. This signaling information is provided by the W-IAD 112. As another example, the W-ATA 112 may signal only certain C-ATAX's 104 and wireless handset's 118. In another example the W-IAD 112 may provide alert tones to the C-ATAX 104 if all the W-IAD's voice lines are in use. In another example, the C-ATAX 104 and the wireless handset 118 may be capable of receiving and switching between two calls by pressing a key sequence, for example *1, on the telephone 102 connected to the C-ATAX 104 or by pressing a line 1 or line 2 button on the wireless handset 118. Alternatively, the C-ATAX 104 and the wireless handset may receive a voice command or other recognition tone to switch between two calls.

The wireless link between the C-ATAX 104 and wireless handset 118 and either the W-ATA 108 or the W-IAD 112 may be based on the readily available 900 MHz/2.4 GHz/5.8 GHz Digital Enhanced Cordless Telephone (DECT) standards used in Europe or the Wideband Digital Enhanced Cordless Telephone (WDECT) standards used in the United States. As another example, the wireless link may be a Wi-Fi type connection (e.g., 802.11x), Bluetooth, or some other wireless connection now available or developed in the future.

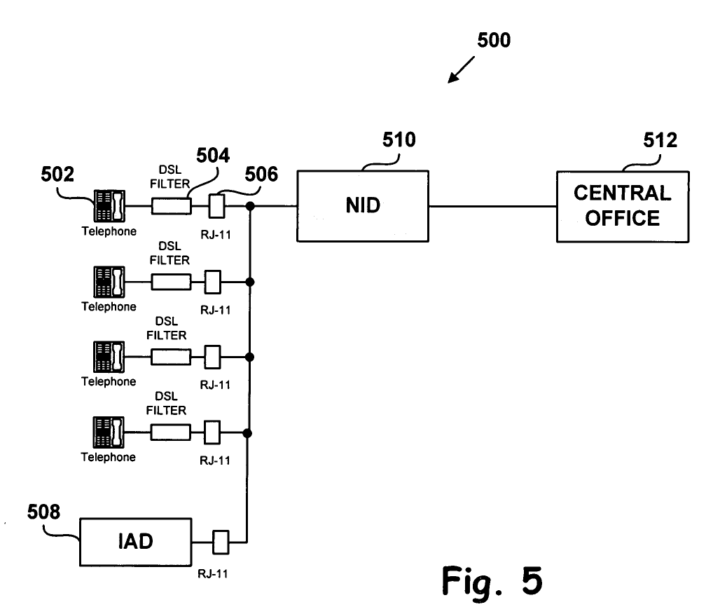

Additionally, the C-ATAX 104 can be equipped with a second RJ-11 jack (as known in the art, the first RJ-11 is connected to the telephone 102 as depicted in FIG. 5) and a relay. The RJ-11 jack may be wired over to the nearest telephone jack that has direct access to the PSTN. In the event of a power failure, the relay activates and switches the user's POTS telephone 102 from a wireless connection to the analog PSTN, which ensures life-line availability.

One benefit of this example is that multiple telephones may be supported with this approach. Each telephone can access the same extension/telephone number (bridge mode) in the same fashion most homes have their telephone wiring configured. Alternatively, each telephone could also have its own VOIP telephone number, allowing for multiple, separate, and simultaneous VOIP calls in the home.

As another alternative, each telephone can be provided with its own extension, while allowing two or more simultaneous WAN based calls. In this example, each telephone rings for its VOIP number coming in until the maximum number of calls supported by the W-IAD 112 over the WAN interface is achieved. Subsequent calls may not be delivered to the C-ATAX 104, but the calls may alert the user via a ring tone than another incoming call is present. Alternatively the call may be transferred to a voice messaging system with an alerting tone indicating that a third call message has been received.

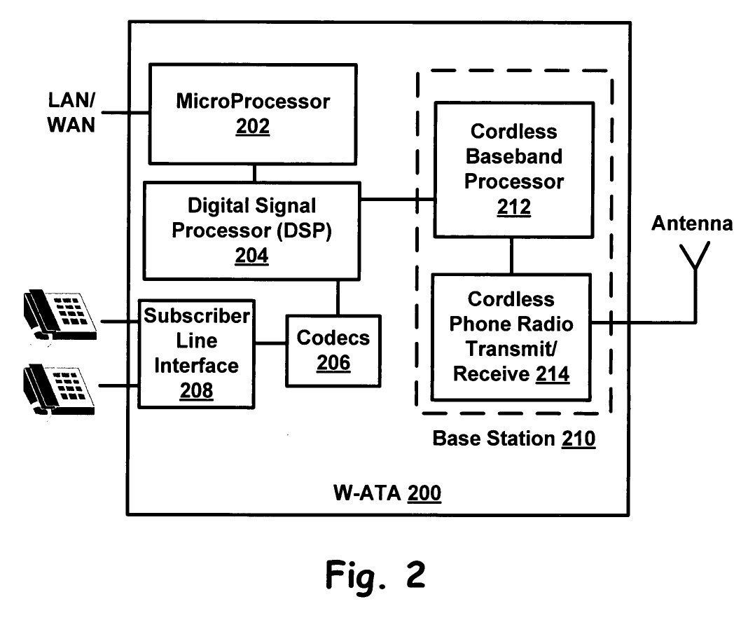

FIG. 2 is a block diagram of a W-ATA 200 for use in the distribution system 100 depicted in FIG. 1. The W-ATA 200 is substantially the same as the W-ATA 108 depicted in FIG. 1. The W-ATA 200 includes a microprocessor 202. The microprocessor 202 may be any type of processor, controller, or other device that processes data, such as an Application Specific Integrated Circuit (ASIC). The microprocessor 202 typically includes an input/output (I/O) interface, and an internal power supply or a means to connect to an external power source. The microprocessor 202 may provide software control, including VOIP signaling using Session Initiated Protocol (SIP) or any other appropriate protocol, such as MGCP or H.323.

The W-ATA 200 also includes an ATA Digital Signal Processor (DSP) 204. The DSP 204 performs compression, echo cancellation, and tone generation/detection. The DSP 204 may provide for the use of special ring tones. The W-ATA 200 may also include codecs 206 and subscriber line interface circuitry (SLIC) 208 for connection to analog telephones.

The W-ATA 200 also includes a Base Station 210. The Base Station 210 includes a Cordless Baseband Processor 212 and a Cordless Phone Radio Transmit/Receive interface 214. The Cordless Baseband Processor 212 supports modulation and demodulation of the radio signal using DECT, WDECT, Wi-Fi, Bluetooth, or any other appropriate access schemes. The Cordless Phone Radio Transmit/Receive interface 214 provides the radio frequency processing and amplification/detection from the RF frequencies, such as 900 MHz, 1.9 GHz, 2.4 GHz, 5.8 GHz, or other spectrum, to baseband. The Base Station 210 supports one or more voice channels simultaneously.

The interface between the Base Station 210 and voice circuitry is shown in FIG. 2 as a digital interface between the ATA DSP 204 and the Cordless Baseband Processor 212. However, the interface is not limited in this manner. For example, an analog interface through the SLIC/codec 206, 208 is also possible.

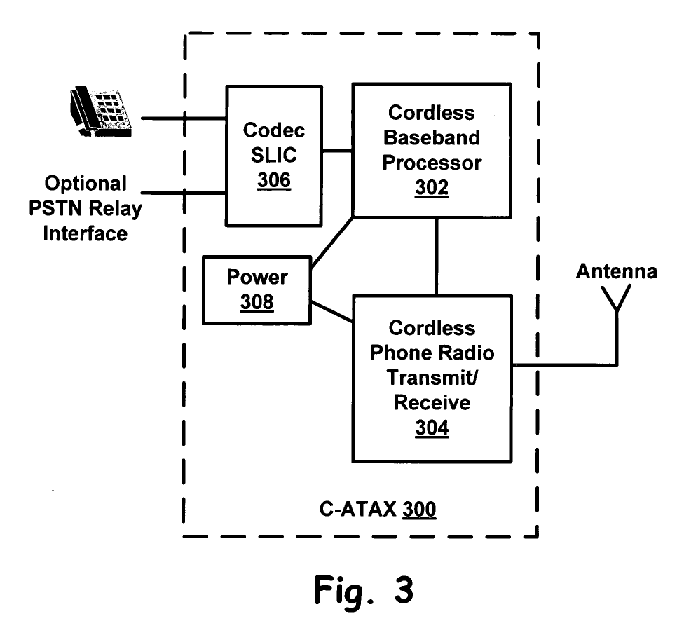

FIG. 3 is a block diagram of a C-ATAX 300 for use in the distribution system 100 depicted in FIG. 1. The C-ATAX 300 is substantially the same as the C-ATAX 104 depicted in FIG. 1. The C-ATAX 300 includes a cordless baseband processor 302, a cordless phone radio transmit/receive block 304, a SLIC/codec 306, and a power source 308. The SLIC/codec 306 may be used for connection to analog telephones, cordless telephones, FAX machines, and other wired devices. The C-ATAX 300 may also include a PSTN fallback relay to the SLIC/codec 306, which optionally connects the C-ATAX 300 to the PSTN upon power fallback or the user pressing a keystroke, such as *8. The keystroke can also be used to switch between one or more active calls by signaling to the W-ATA 108 that the C-ATAX 300 desires to be on a different call.

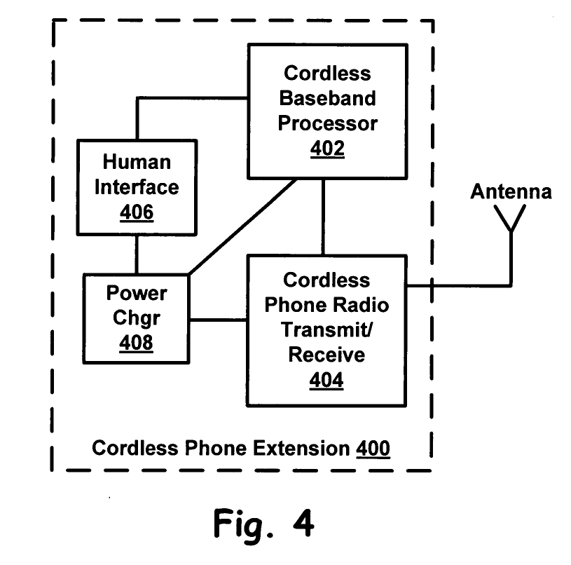

FIG. 4 is a block diagram of a cordless telephone extension 400 for use in the distribution system depicted in FIG. 1. The cordless telephone extension 400 is substantially the same as the wireless handset 118 depicted in FIG. 1. The cordless telephone extension 400 includes a cordless baseband processor 402, a cordless phone radio transmit/receive block 404, a human interface 406, and a power charger 408. A keystroke can be used to switch between one or more active calls by signaling to the W-ATA 108 that the cordless telephone extension 400 desires to be on a different call. The cordless telephone extension 400 may be capable of answering one or more calls by selecting line 1 or line 2 in addition to using a key sequence (e.g., *8) to switch between the calls or an analog line.

Both the C-ATAX 300 and the cordless telephone extension 400 may be capable of receiving distinctive ring tones and forwarding them to the telephone 102 or user interface 406 visually or via melody or distinctive ring pattern when the C-ATAX 300 is connected to the telephone 102. The cordless telephone extension 400 and the C-ATAX 300 are also capable of receiving data from W-ATA 108 and displaying the data over IP or other cordless interfaces.

Adding an Isolator to a Network Interface Device

In another example, a user can place VOIP calls with the same degree of freedom the user has with conventional telephone service by adding an isolator to a Network Interface Device (NID). In this example, the user can make VOIP calls from their existing telephones over their existing in-home wiring. This solution is described in more detail with respect to FIGS. 5-7.

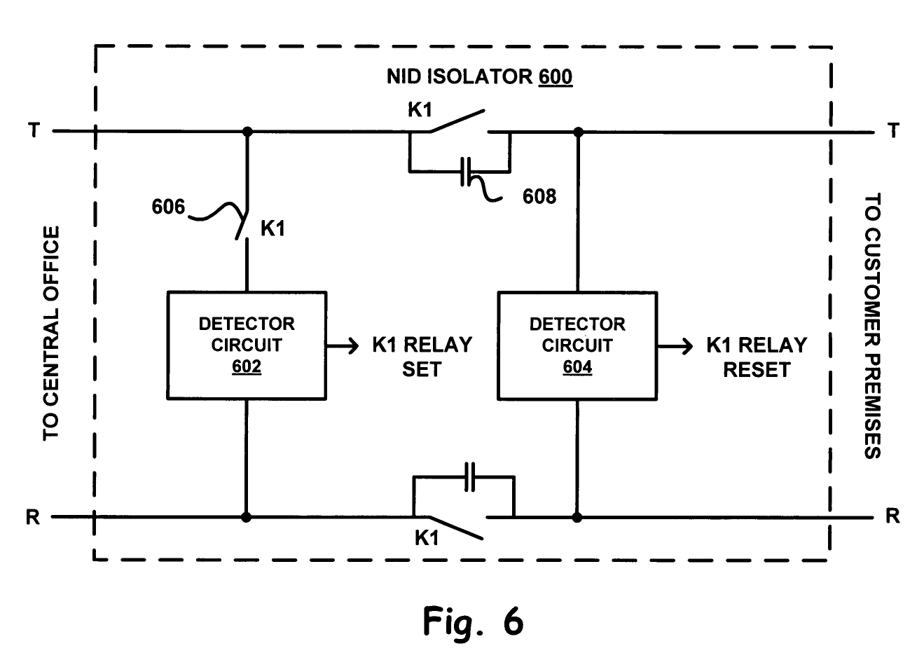

FIG. 5 is a block diagram of distribution system 500. The system 500 includes a NID 510. The NID 510 is a conventional device known in the art, which is typically found on the outside of a user's home. The NID 510 connects in-home wiring to the telephone network and, thus, may be considered as the dividing line between the customer premises in-home wiring and the wiring connected to a Central Office 512. The NID 510 includes an isolating device 600, which is described in more detail with reference to FIG. 6.

The distribution system 500 includes customer premises equipment (CPE). In this example, the CPE includes a plurality of standard POTS telephones 502 and an IAD 508. It is understood that the CPE can include a wide variety of different equipment and is not limited by this example. Each of the telephones 502 are connected to the customer premises in-home wiring via a DSL filter 504 and an RJ-11 jack 506. The IAD 508 is connected to the customer premises in-home wiring via an RJ-11 jack 506. The use of DSL filters and jacks to connect CPE to in-home wiring is well-known in the art. One or more personal computers or other devices (not depicted in FIG. 5) may be connected to the IAD 508.

The IAD 508 communicates with the isolating device 600 to control the isolating device 600. When the IAD 508 activates the isolating device 600, the isolating device 600 blocks the customer premises analog POTS service from the Central Office 512, while allowing a DSL signal to pass. Once the isolating device 600 is activated, calls made from any telephone in the house are routed through the IAD 508, converted to VOIP, and sent out to a digital network, such as the Internet, via DSL transport.

The IAD 508 may communicate with the isolating device 600 using a wide variety of methods, such as using tones or DC signaling. For example, by using flash hook or * tones, the individual POTS telephones may alert the IAD 508 to switch the NID 510 between POTS and VOIP operation.

Additionally, if power is lost at the IAD 508 or if the IAD 508 is removed, the isolating device 600 releases due to the loss of “IAD to NID-isolator” communications, reconnecting the user's analog POTS service to the Central Office 512. As a result, life-line availability is maintained.

FIG. 6 is a schematic of a NID isolator 600 for use in the NID 510 depicted in FIG. 5. The NID isolator 600 includes a first detector circuit 602 and a second detector circuit 604. Additionally, the NID isolator 600 includes relays 606 and capacitors 608. The NID isolator 600 is not limited to this example and may include different components.

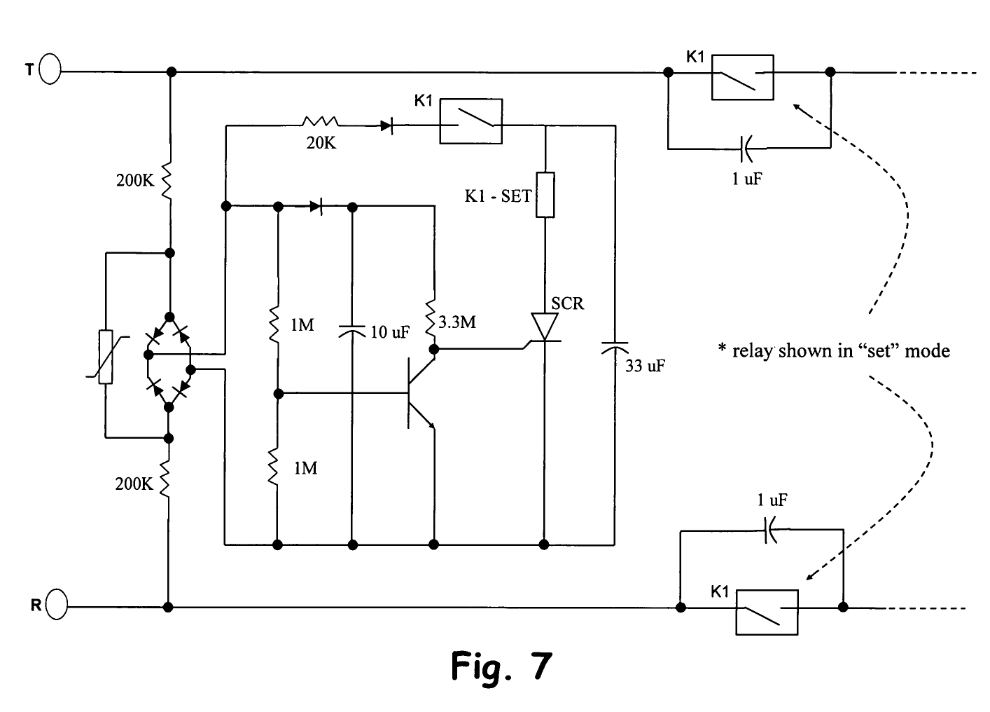

An example schematic of the first and second detector circuits 602, 604 is depicted in FIG. 7. The first and second detector circuits 602, 604 may be designed as high impedance circuits that function to detect battery open and battery short circuit conditions. The first and second detector circuits 602, 604 may be substantially the same. Alternatively, the first and second detector circuits 602, 604 may be different. For example, the second detector circuit 604 may also include a POTS attenuation circuit.

Until the IAD 508 is installed at the customer premises, the NID 510 remains in POTS mode. After the IAD 508 is installed, the IAD 508 starts a DSL initialization sequence. During the initialization sequence, the IAD 508 identifies the line status. The line status may be idle, ringing, off-hook, or fault (e.g., short). If the line is in use (i.e., off-hook or ringing) or a fault condition exists, the IAD 508 delays initiation of VOIP service. If the line is idle and the CO battery is detected, the NID 510 is in POTS mode. However, if the line is idle and the CO battery is not detected, the NID 510 is not in a correct state and an error message may be generated.

Once determining VOIP service is possible, the IAD 508 activates the NID 510 to sync the DSL for communication with the digital network. The IAD 508 applies a short to simplex leads for approximately three seconds. The IAD 508 then checks that the CO battery is no longer present indicating that the NID 510 relay has fired and applied the talk battery to the tip/ring leads. By applying the talk battery to the tip/ring leads, the detector circuit 604 is prevented from releasing the NID 510. The NID 510 is now in VOIP mode. The NID 510 remains in VOIP mode until the IAD 508 is removed, loses power, or a short is applied to the tip/ring leads on the customer premises side.

Adding an Isolator to a Central Office

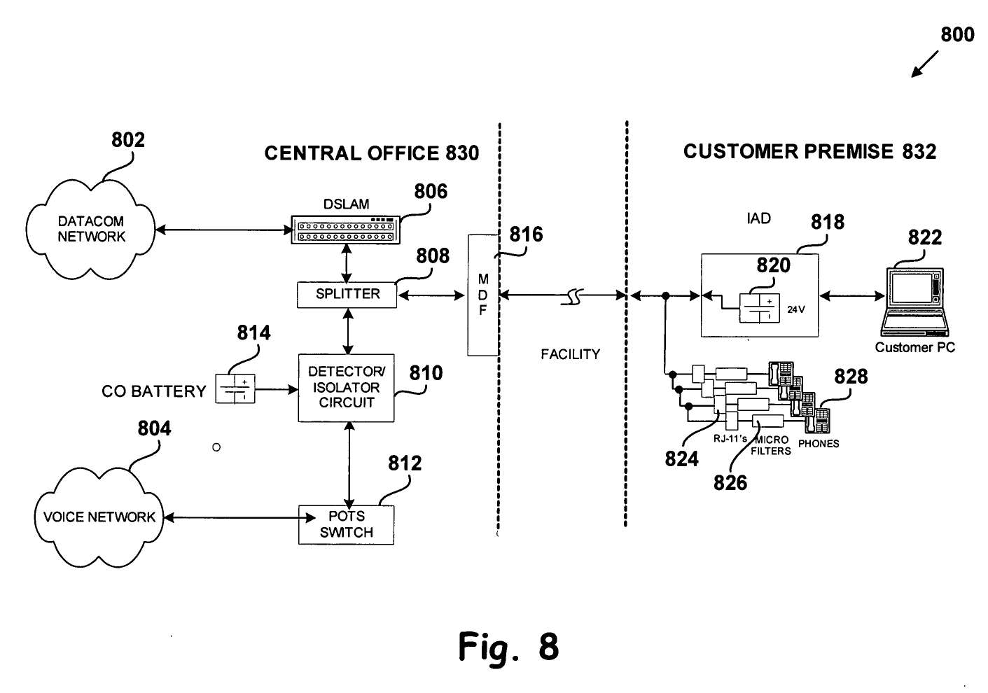

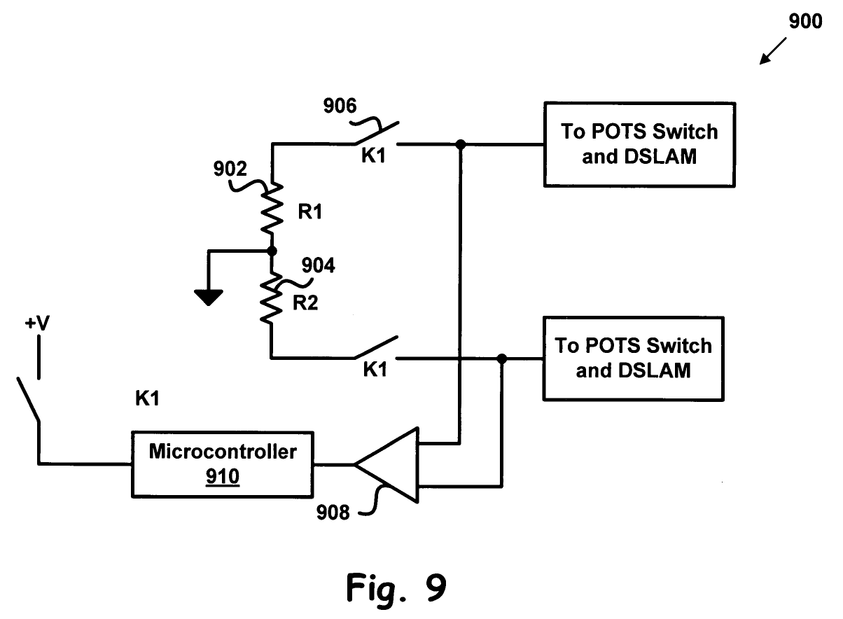

In another example, a user can place VOIP calls with the same degree of freedom the user has with conventional telephone service by adding an isolator to a Central Office. In this example, the user can make VOIP calls from their existing telephones over their existing in-home wiring. This example is described in more detail with respect to FIGS. 8-9.

FIG. 8 is a block diagram of distribution system 800. The distribution system 800 depicts a Central Office 830 and a Customer Premise 832. The Customer Premise 832 includes an IAD 818, which has a battery 820. The in-home wiring is connected to the IAD 818, which provides the interface with a personal computer 822 and/or other devices that communicate using a data network. The in-home wiring is also connected to an RJ-11 jack 824, which is connected to a DSL filter 826, which in turn is connected to a standard POTS telephone 828. As shown in FIG. 8, any number of telephone connections may be found in the home.

The Central Office 830 includes a Digital Subscriber Line Access Multiplexer (DSLAM) 806, a splitter 808, an isolator circuit 810, a battery 814, and a POTS switch 812. The Central Office 830 is connected to a data network 802 via the DSLAM 806 and a voice network 804 via the POTS switch 812. Additionally, the Central Office 830 is connected to the Customer Premises 832 via a Main Distribution Frame (MDF) 816. The MDF 816, which is well known in the art, is the termination point for external truck cables entering the Central Office 830.

When an IAD 818 is not present in a Customer Premises 832, the isolator circuit 810 allows analog POTS service to pass through normally. However, once an IAD 818 is installed and presents a voltage signal (typically, 24 volts) via the battery 820 onto the tip and ring lines, the isolator circuit 810 detects a voltage differential between the Central Office 830 and the IAD 818. Upon detection of the voltage differential, the isolator circuit 810 activates a relay to disconnect the POTS switch 812 from the isolator circuit 810. While this example uses DC signaling to initiate the isolation function, other communication techniques could also be used, such as using tones.

Once the isolator circuit 810 is activated, calls made from any telephone in the home are routed through the IAD 818, converted to VOIP, and sent out to the Internet via DSL transport through the DSLAM 806. The DSLAM 806 is a device known in the art for taking connections from many customers and aggregating them into a single, high-capacity connection to the Internet. The DSLAM 806 may provide additional functions, such as routing and dynamic IP address assignment.

By including the isolation function to the Central Office 830, installation is simplified. For example, to install the isolator circuit 810 into the customer premises, such as the NID, a service technician needs to travel to the home. The Central Office solution eliminates the need to install equipment at the customer premises. Additional economies may be realized by including the isolator function to the Central Office 830 because one isolator circuit 810 may be used for multiple users. For example, one isolator circuit 810 may support 25-50 users.

FIG. 9 is a schematic of an isolator circuit 900 for use in the distribution system 800 depicted in FIG. 8. The isolator circuit 900 includes a first resistor 902 (R1), a second resistor 904 (R2), a relay 906 (K1), a differential amplifier 908, and a microcontroller 910. The relay 906 includes three switches. The isolator circuit 900 is not limited to this example and may include different components.

The isolator circuit 900 acts as a slave of the IAD 818 when installed, and responds to conditions of the lines and signaling from the IAD 818. The trigger for the circuit of 900 is the amplifier 908, which is connected to the microcontroller 910. The microcontroller 910 detects the output of the amplifier 908 and fires the relay 906 if a threshold is exceeded. The isolator circuit 900 monitors the differential voltage across the POTS switch 812 when in POTS mode, and across R1 902 and R2 904 in VOIP mode. R1 902 and R2 904 provide a light termination in VOIP mode.

The IAD 818 is the master of the isolator circuit 900. The IAD 818 monitors the line for operating conditions when in POTS mode and identifies when to activate the VOIP mode. When the IAD 818 identifies its time to activate VOIP mode, the IAD 818 signals to the isolator circuit 900 to activate the relay 906 and remove the CO battery 814 from the line. The IAD 818 then verifies the open line and activates the VOIP mode by applying the talk battery 820 to the CPE equipment.

Using the Outer Pair of Telephone Wires

In another example, a user can place VOIP calls with the same degree of freedom the user has with conventional telephone service by using the outer pair of telephone wires. Normally, homes are installed with two pairs (four wires total) of telephone wires, typically referred to as the inner pair and the outer pair. The inner pair of wires supports POTS service, while the outer pair of wires is reserved for a second telephone line.

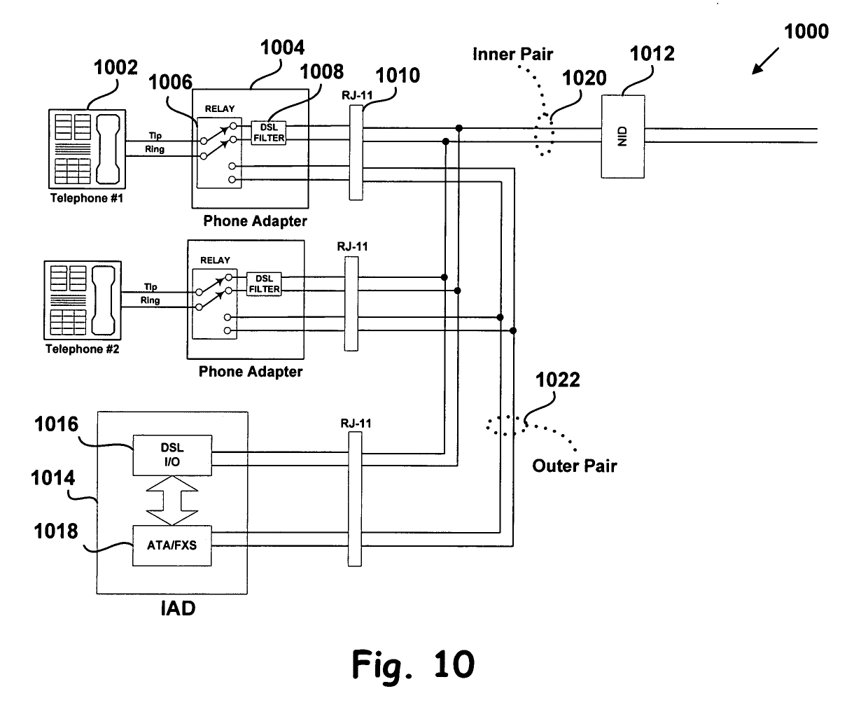

The outer pair of wires is typically not used. In this example, the second pair of wires is used to offer VOIP service. As a result, the user may use the second pair of wires to make VOIP calls from their existing telephones. This solution is described in more detail with respect to FIG. 10.

FIG. 10 is a block diagram of distribution system 1000. The distribution system 1000 includes a standard POTS telephone 1002 connected to an adapter 1004. Two wires, the tip and the ring lines, are connected between the telephone 1002 and the adapter 1004. The adapter 1004 includes a relay 1006 and a DSL filter 1008. The adapter 1004 is also connected to a RJ-11 jack 1010.

The adapter 1004 provides at least two functions. First, the adapter 1004 connects the telephone 1002 to the inner pair of wires 1020 through the DSL filter 1008 so that the user can make normal POTS calls. This connection is depicted in FIG. 10. Second, the adapter 1004 provides the relay 1006 for switching the telephone's tip/ring connections from the inner pair of wires 1020 to the outer pair of wires 1022 for VOIP functionality.

The distribution system 1000 also includes an IAD 1014. The IAD 1014 includes a DSL interface 1016 and Analog Telephone Adapter/Foreign Exchange Station (ATA/FXS) circuitry 1018. The IAD 1014 is connected to both the inner pair of wires 1020 and the outer pair of wires 1022. The inner pair of wires 1020 is connected to the DSL interface 1016, while the outer pair of wires 1022 is connected to the ATA/FXS circuitry 1018.

The relay 1006 in the adapter 1004 may be controlled using a wide variety of methods, such as using tones or DC signaling. For example, by using flash hook or * tones, the individual POTS telephones could control the relay 1006 to switch between POTS and VOIP operation. Once the adapter 1004 switches the telephone 1002 to the outer pair of wires 1022, calls made from the telephone 1002 are routed through the ATA/FXS circuitry 1018, converted to VOIP, and sent out to a digital network, such as the Internet, via DSL transport. As a result, the user can make VOIP calls with his existing telephone 1002 and in-home wiring.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. An in-home Voice-Over-Internet Protocol (VOIP) telephony distribution system, comprising in combination:
at least one of a cordless analog telephone adapter extension connected to a wired communications device and a wireless handset; and
a wireless integrated access device connected to a broadband network, wherein the wireless integrated access device communicates wirelessly with the at least one of the cordless analog telephone adapter extension and the wireless handset.

2. The system of claim 1, wherein the wired communications device is a device selected from the group consisting of a landline telephone, a cordless telephone, a facsimile machine, and a text telephone device.

3. The system of claim 1, wherein the wireless integrated access device includes a modem and a wireless analog telephone adapter.

4. The system of claim 3, wherein the wireless analog telephone adapter is an analog telephone adapter that is modified by adding wireless access to an analog voice interface of the analog telephone adapter.

5. The system of claim 1, wherein the broadband network is selected from the group of networks consisting of Internet, Intranet, Integrated Service Digital Network (ISDN), Digital Subscriber Line (DSL), cable, frame relay, Ethernet, wireless, and satellite.

6. The system of claim 1, wherein the wireless integrated access device communicates wirelessly with the at least one of the cordless analog telephone adapter extension and the wireless handset via a wireless link that is based on a standard selected from the group consisting of Digital Enhanced Cordless Telephone (DECT), Wideband Digital Enhanced Cordless Telephone (WDECT), Bluetooth, Ultra Wide Band (UWB), and Wireless Fidelity (Wi-Fi).

7. The system of claim 1, wherein the wireless integrated access device provides distinctive ring tones based on an identity of a caller.

8. The system of claim 1, wherein the wireless integrated access device selects a particular extension to ring.

9. The system of claim 1, wherein the wireless integrated access device supports multiple telephone calls at the same time.

10. The system of claim 9, wherein a user is able to select between the multiple telephone calls.

11. The system of claim 1, wherein the wireless integrated access device receives more incoming calls than can be supported simultaneously and sends an alert call to the at least one of the cordless analog telephone adapter extension and the wireless handset to alert a user that another inbound call is present.

12. The system of claim 11, wherein the user is able to place a current call on hold and answer the alert call.

13. The system of claim 12, wherein the user switches to the alert call by pressing a key on the at least one of the wired communication device and the wireless handset.

14. The system of claim 12, wherein the user switches to the alert call using voice commands.

15. The system of claim 1, wherein the cordless analog telephone adapter extension includes a PSTN fallback relay that connects the cordless analog telephone adapter extension to the PSTN upon at least one of a power fallback and a user pressing a keystroke.

16. A method of providing in-home Voice-Over-Internet Protocol (VOIP) telephony distribution, comprising in combination:
connecting a wired communications device to a cordless analog telephone adapter extension; and
connecting a wireless integrated access device to a broadband network, wherein the wireless integrated access device is operable to communicate wirelessly to the cordless analog telephone adapter extension.

17. A Voice-Over-Internet Protocol (VOIP) telephony distribution system, comprising in combination:
a wired communications device connected to in-home wiring;
an integrated access device connected to the in-home wiring; and
an isolator controlled by the integrated access device, wherein the operational status of the isolator determines whether the wired communications device provides VOIP service.

18. The system of claim 17, wherein the isolator is located in a network interface device.

19. The system of claim 17, wherein the isolator is located in a Central Office.

20. The system of claim 17, wherein the integrated access device controls the operational status of the isolator with at least one of tones and DC signaling.

21. An in-home Voice-Over-Internet Protocol (VOIP) telephony distribution system, comprising in combination:
an adapter for switching between a first pair of wires and a second pair of wires; and
an integrated access device connected to the first pair of wires and the second pair of wires, wherein when the adapter connects a telephone to the first pair of wires the telephone receives Plain Old Telephone Service (POTS), and wherein when the telephone adapter connects the telephone to the second pair of wires the telephone receives VOIP service.

22. The system of claim 21, wherein the adapter includes a relay for switching between the first pair of wires and the second pair of wires.

23. The system of claim 21, wherein a Digital Subscriber Line (DSL) interface in the integrated access device is connected to the first pair of wires.

24. The system of claim 21, wherein Analog Telephone Adapter/Foreign Exchange Station (ATA/FXS) circuitry in the integrated access device is connected to the second pair of wires.

25. The system of claim 21, wherein the adapter is controlled with at least one of tones and DC signaling.
